(19) United States
(12) Patent Application Publication
(10) Pub. No.: US 2006/0006013 A1
(43) Pub. Date: Jan. 12, 2006

(54) Cruise control system for motor vehicles

(75) Inventors: Olaf van der Kaay, Doetinchem (NL); Henrikus Johannes Maria Linneman, Zevenaar (NL); Marko Alexander Kleij, Duiven (NL)

Correspondence Address: DELLETT & WALTERS, P. O. BOX 82788, PORTLAND, OR, 97282-0788, US

(73) Assignee: LITE-ON AUTOMOTIVE CORP.

(21) Appl. No.: 11/174,323

(22) Filed: Jul. 1, 2005

(30) Foreign Application Priority Data
Jul. 9, 2004 (DE) 20 2004 010841.0

(51) Int. Cl. B60K 31/00

(52) U.S. Cl. 180/170

(57) ABSTRACT

An after market cruise control system has a speed cruise control unit to produce electronic control signals, a power control equipment for supplying fuel to a combustion chamber of an internal combustion engine, a mechanical operated accelerating transmitter for providing an electric signal output and a motor management system for processing output signals of the signal output and for electrically driving the power control equipment, The control signal of the cruise control unit for the power control equipment is transmitted to an interface unit that is defined between the electric signal output of the accelerating transmitter and the motor management system, and the interface unit is so equipped that it transmits the output signal or the control signal or a combination signal of both signals to the motor management system.

### BACKGROUND OF THE INVENTION

1. Field of the Invention

The present invention relates to a cruise control system for motor vehicles, and more particularly to an after market cruise control system for vehicles with a cruise speed control unit to produce control signals through an operating element by an operator.

2. Description of Related Art

Currently, cruise control in vehicles is well-known as a mechanical connection between the accelerator pedal and the power control equipment (for example the throttle lever or the throttle valve). Specifically, the cruise control comprises a cruise speed control unit, an input unit for setting or inputting a desired cruise speed and a driving-equipment for controlling the accelerator pedal, especially in the form of a servo-motor and its necessary coupling. The cruise speed control unit controls the speed under the inputs from the driver through mechanical position of the accelerator pedal with help of the driving-equipment. It is noted that the position of the accelerator pedal is directly adjusted through the mechanical connection to the power control equipment to control the power of the motor.

After market cruise control is also applied in vehicles with an electrical acceleration-control. The electrical acceleration-control comprises a motor management system and a throttle lever or pedal without direct mechanical connection between them. An accelerator-sensor is put on the accelerator pedal to detect the position of the accelerator pedal and gives an electrical signal to the motor management system. Then the motor management system regulates the speed through the power control equipment of the motor based on the signal coming from the accelerator sensor. These system types are called “drive-by-wire.” The present invention relates to such a “drive-by-wire” system. An after market type of such cruise speed control system is obtainable. It also comprises a cruise speed control unit, an input unit for setting up the desired cruise speed and a driving-equipment for controlling the accelerator pedal, particularly in form of a servo-motor type, and its necessary mechanical coupling. The cruise speed control unit controls the speed based on the inputs from the driver through the mechanical position of the accelerator pedal with help from the input unit. The position of accelerator pedal is sensed and electrically given to the power control equipment to control the power of the motor.

Considering the available space in vehicles, installing cruise control in a “drive-by-wire” system is difficult and also brings about some delay of reaction time.

### SUMMARY OF THE INVENTION

The primary objective of the present invention is to provide an improved after market cruise control system to overcome the drawbacks of current after market cruise control systems. The present invention provides an improved cruise control system to solve the aforementioned problems.

Other objects, advantages and novel features of the invention will become more apparent from the following detailed description when taken in conjunction with the accompanying drawings.

### DESCRIPTION OF THE DRAWINGS

FIG. 1 is a block diagram of a cruise control system in accordance with the present invention, wherein the cruise control system is unified within a “drive-by-wire” system.

### DETAILED DESCRIPTION OF PREFERRED EMBODIMENT

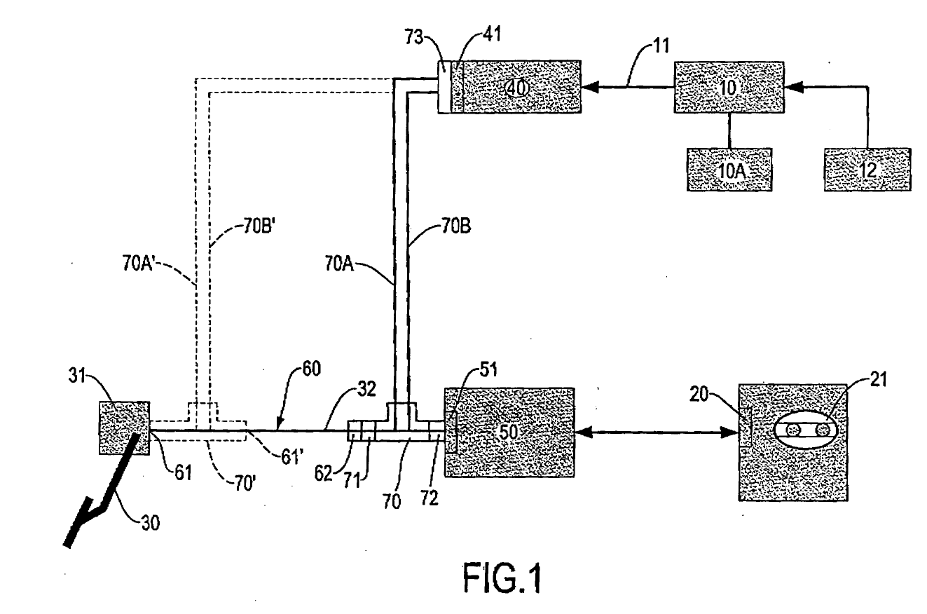

With reference to FIG. 1, a “drive-by-wire” system includes an accelerating transmitter, as a rule in form of an accelerator pedal (30), a signal output (31), a motor management system (50) for a specific motor, and a power control equipment (20). For example, the system can be defined in cooperation with an internal combustion motor, an electrical motor, a fuel cell-motor or other propulsion motors (21), for instance for vehicles. Without the cruise control system, an output signal (32) will be produced at the signal output (31) in dependence upon the position of accelerator pedal (30) that is operated by a driver, and will be subsequently transmitted to the motor management system (50). The motor management system (50) converts the output signal (32) and drives the power control equipment (20) over an, for the most part electric, connection to reach or maintain the speed desired by the driver. As a rule, the signal process mechanisms in the motor management system (50) are only known by authorized people, since the motor controls from automobile manufacturers provided for use with specific motor-performance-systems are so called “black-boxes.” However, the output signal (32) of the signal output (31) is dependent on the position of the accelerator pedal (30) and is well known therefore.

The cruise control system in accordance with the present invention includes an interface unit (40), as well as the familiar cruise speed control unit (10) and an operation element (12) that is well-known as an input unit in different variants. By its help, the cruise control can provide for instance a given speed. The operation element (12) is mounted in the vehicle cabin near the steering wheel. The operation element (12) also can be mounted in the knob of S the gearshift lever, to distract the concentration of a driver as little as possible. This type of operation element (12) is of inventive meaning by its own.

The interface unit (40) is located between the accelerator (30) and the motor management system (SO) in a way that the signal output (31) is not directly connected to the motor management system (50), but instead with the interface unit (40), from where signals are transmitted to the motor management system (50). The cruise speed control unit (10) is connected to the interface unit (40) as well. The cruise speed control unit (10) is also connected (electrically or by radio, infra-red or the other wireless ways) to the operation element (12).

The connection between the signal output (31) of the accelerator pedal (30) and the motor management system (50) is made through a junction cable (60) that is (OEM wise) equipped with specific connectors (61, 62) at two ends thereof, for a given (OEM) specific motor or vehicle, For the purpose of easy assembly and universal application for the cruise control in accordance with the present invention, the electric intermediate connections of the interface unit (40) are made through additional junction cables (70A, B) having an attachment connector (70), which is, preferably, T-shaped. The attachment connector (70) is equipped at its T-shaped ends, with connectors (71, 72) which are specific for the motor or for the vehicle so that the intermediate connections of the junction cables (70A, 70B) can be connected problem-free between the accelerator pedal (3)) and the motor management system (50) either to the signal output (31) of the accelerator (30) (as shown in dotted line) or the motor management system (50) (as shown in solid line). In the first case, the signal output (31) is connected electrically through attachment connector (70′), junction cables (70A′, 70B′), connector socket or connector plug (73) and connector (41) to the interface unit (40). The connector (41) is part of the interface and independent a specific vehicle, so that the interface unit (40) is usable universally, and installation S within a specific vehicle only requires connecting the junction cables (70A′, B′) by means of attachment connector (70′), which will be placed between the signal output (31) and the correspondent plug connector (61). In the other (second) case, the plug connection (62, 51) is detached, and the attachment connector (70) is plugged with its plug connectors (71, 72) between Connection ports (62) and (51). In both cases, the original junction cable (60) remains in its original position in the vehicle

With the cruise control system in its switched off status, the interface unit (40) sends the output signal (32) from the signal output (31) to the motor management system (50), so maintaining the vehicles speed control according to the position of the accelerator pedal (30). If the cruise control system is switched on through the operation element (12) and a speed is programmed (chosen), the interface unit (40) sends a signal to the motor management system (50), which is a control or switch signal (11) coming from the cruise speed control unit (10) or a mixed signal of the output signal (32) and the switch signal (11), which mixed signal is related to the position of the accelerator pedal (30). Therefore mechanical fixtures, for example a servo-motor for moving the accelerator pedal (30), are not necessary. In addition, the interface unit (40) receives the signals from the signal output (31).

When the driver presses the accelerator pedal (30) down to increase the speed above the programmed speed of the cruise control, the interface unit (40) reacts, according to one of the embodiments of the invention, and sends a signal to the motor management system (50) to increase speed. The total process is carried out with the cruise control being switched on, as long as the increased speed is within given safety limits of the cruise control safety-function.

When the driver wants to drive at a programmed speed of the cruise control system and does not want to operate the accelerator pedal (30), the interface unit (40) provides a signal to the motor management system (50) dependent on the switch signal (11). Since the signal is as a rule not constant because of different power demands on the motor (e.g. going uphill and downhill at a constant speed), the interface unit (40) has to “know” which mode of signal must be transmitted to the motor management system (50), to increase power to go uphill, for example. To maintain the universality, the present invention has advantageously proved that the interface unit (40) learns independently which mode is required and sends the necessary signal. In that case, it is possible that the output signal (32) coming from the signal output (31) is “known” by the interface unit (40). For that reason, a short learning phase is required to learn a rule, and a complete spectrum of all possible signal-outcomes will be transmitted to the interface unit (40) when the accelerator is pressed. Different learning modes may be programmed, in order to offer an efficient and reliable study tool.

In addition to the foregoing feature, the interface unit (40) can be told or may include some information about the specific vehicle type/types so that the T-shaped interface cable for a specific vehicle will be “recognized”. This would allow for conclusions with respect to the vehicle type and its steering systems, so all the information will be “known” by the interface unit (40). To make such recognition possible, the simplest way is to have more of multiple connecting pins than needed at the connector (41) of the interface unit (40) for transmitting of signals through the input and the output. By doing so, a “cable connection” accomplished over the junction cables (70A′, 70B′) is “specific” for a certain type of vehicle or motor and will be “recognized” by the interface unit (40). The pin structure of the attachment connector (73) that is also defined with more multiple connecting pins than being needed in the single case are then for a specific junction cable (70A,70B or 70A′,70B′). Beyond this, more complex possibilities are also conceivable, especially through sensor controlled recognizing.

The cruise control system in accordance with the present invention has other capabilities besides purely controlling speed, for example the safety functions of switching off or uncoupling the cruise control system, for example when the brake or accelerator pedal (30) is pressed, the switch-off operation at the operation element (12), the over-speed of the motor, the deceleration or acceleration of the vehicle within speed limits (for example from 75% to 150%) and the supervision and consideration of the ignition.

The operation element (12) also may have other helpful functions, for example working with a readable memory (10A), so that the programmed speeds which are allowed for different traffic zones (of a city or highway) or ground situations would be retrieved by pressing a button (memory function). The entire system effectively prevents speeding, as long as the function is on.

Consumers can combine the functions to meet their own needs.

Even though numerous characteristics and advantages of the present invention have been set forth in the foregoing description, together with details of the structure and function of the invention, the disclosure is illustrative only. Those changes may be made in detail, especially in matters of shape, size, and arrangement of parts within the principles of the invention to the fill extent indicated by the broad general meaning of the terms in which the appended claims are expressed.

What is claimed is:

1. A cruise control system for motor vehicles, the cruise control system comprising;
a mechanical operating accelerating transmitter having an electric signal output(31);
a motor management system (50) electrically connected to the mechanical operating accelerating transmitter to process output signals (32) of the signal output (31);
an interface unit (40) connected between the electric signal output (31) of the accelerating transmitter and the motor control management(50) to transmit the output signal (32) to the motor management system (50);
a cruise speed control unit (10) connected to the interface unit (40) to provide electronic control signals (11) by an operation element (12) to the interface unit (40); and
a power control equipment (20) connected to and driven by the motor management system to supplying fuel to a combustion chamber of an internal combustion engine.

2. The cruise control system as claimed in claim 1, wherein the control signal (11) transmitted to the interface unit (40) is combined with the output signal (32) of the signal output (31) and is transmitted to the motor management system (50).

3. The cruise control system as claimed in claim 2, wherein the interface unit (40) further has a connector (41) with multiple pin connections for transmission of the output signals (32) to the motor management system (50).

4. The cruise control system as claimed in claim 3, wherein the connector (41) of the interface unit (40) is electrically connected to an attachment connector (70) by junction cables (70A, B).

5. The cruise control system as claimed in claim 4, wherein the attachment connector (70) is in a plug connection between the electric signal output (31) and a junction cable (60) that is connected to the motor management system (50).

6. The cruise control system as claimed in claim 5, wherein the attachment connector (70) is T-shaped.

7. The cruise control system as claimed in claim 6 further comprising a readable memory (10A) connected to the cruise speed control unit (10).

8. The cruise control system as claimed in claim 4, wherein the attachment connector (70) is in a plug connection between a junction cable (60) that is connected to the electric signal output (31) and the motor management system (50).

9. The cruise control system as claimed in claim 8, wherein the attachment connector (70) is T-shaped.

10. The cruise control system as claimed in claim 9 further comprising a readable memory (10A) connected to the cruise speed control unit (10).

11. The cruise control system as claimed in claim 1, wherein the interface unit (40) further has a connector (41) with multiple pin connections for transmission of the output signals (32) to the motor management system (50).

12. The cruise control system as claimed in claim 10, wherein the connector (41) of the interface unit (40) is electrically connected to an attachment connector (70) by junction cables (70A, B).

13. The cruise control system as claimed in claim 11, wherein the attachment connector (70) is in a plug connection between the electric signal output (31) and a junction cable (60) that is connected to the motor management system (50).

14. The cruise control system as claimed in claim 12, wherein the attachment connector (70) is T-shaped.

15. The cruise control system as claimed in claim 13 further comprising a readable memory (10A) connected to the cruise speed control unit (10).

16. The cruise control system as claimed in claim 11, wherein the attachment connector (70) is in a plug connection between a junction cable (60) that is connected to the electric signal output (31) and the motor management system (50).

17. The cruise control system as claimed in claim 15, wherein the attachment connector (70) is T-shaped.

18. The cruise control system as claimed in claim 16 further comprising a readable memory (10A) connected to the cruise speed control unit (10).

19. The cruise control system as claimed in claim 10 further comprising a readable memory (10A) connected to the cruise speed control unit (10).

20. The cruise control system as claimed in claim 2 further comprising a readable memory (10A) connected to the cruise speed control unit (10).
